(19) United States
(12) Patent Application Publication
(10) Pub. No.: US 2002/0184497 A1
(43) Pub. Date: Dec. 5, 2002

(54) Automated multi-user package retrieval and storage system

(76) Inventors: Michael J. Gage, Pasadena, CA (US); Christopher D. Buntine, Pasadena, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/036,180

(22) Filed: Dec. 28, 2001

Related U.S. Application Data
(60) Provisional application No. 60/259,272, filed on Dec. 28, 2000.

(51) Int. Cl. G06F 17/60

(52) U.S. Cl. 713/168; 705/28; 705/400

(57) ABSTRACT

A multi-user package retrieval and storage system, includes one or more delivery node systems having a plurality of storage units and a locker controller that controls access to the storage units and electrically communicates with a back office system via a communication network.

### CROSS REFERENCE TO RELATED APPLICATION

This application claims priority to U.S. Provisional Patent application Serial No. 60/259,272, entitled “AUTOMATED MULTI-USER PACKAGE RETRIEVAL AND STORAGE SYSTEM” filed on Dec. 28, 2000 the content of which is incorporated herein by reference.

This invention was made with Government support under Grant No. CA-26-7021 awarded by the Federal Transit Administration. The Government has certain rights in this invention.

### FIELD OF THE INVENTION

The present invention relates to temporary storage systems, and more particularly, to an automated, multi-user storage system that accepts delivery and provides temporary storage of received items, and provides customers with delivery notification, tracking and account management.

### BACKGROUND

Changes in consumers' buying patterns have driven greater demand for package delivery services. While consumers historically purchased items directly at retail outlets, many consumers now find greater convenience in making purchases remotely, such as by mail order, over the telephone, or online via the Internet. These remotely purchased goods are then delivered to the customer using commercial or postal delivery services. While this form of purchasing presents a tremendous convenience for consumers who no longer have to visit retail outlets and can shop at their convenience, it has a related drawback with respect to being available to receive the package delivery.

For example, home delivery presents a logistics problem for many individuals that work outside the home and who do not have anyone available at the time of delivery to accept receipt of the package. The uncertainty of the delivery time may compound the difficulty of coordinating receipt of the package, as it is usually undesirable for the package to be left unattended at the consumer's doorstep. While these individuals can arrange for delivery of their packages at their workplace, this too may be undesirable as some consumers desire to keep their purchases private. Moreover, delivery at work presents an additional logistical problem of getting the package home for individuals that rely on public transportation.

One solution to this problem has been to have such packages delivered to a postal box within the local Post Office or a commercial postal service provider. A customer can rent a postal box for a predetermined period of time (e.g., monthly), and can arrange to have packages or mail delivered to the postal box. The postal boxes typically comprise individual storage lockers having a key lock for which each respective customer is provided a key. These postal boxes are typically available to customers at most times of day so the customers can retrieve delivered mail and packages at their convenience.

Despite these advantages, there are numerous disadvantages with the use of conventional postal boxes. First, postal boxes have a fixed size determined by the monthly rental charge. Package deliveries that exceed the postal box size often cannot be accepted. Second, a customer receives no notification that a delivery has been made to the postal box. Therefore customers must periodically check in person to see if such deliveries have arrived at their postal boxes. Third, since the postal boxes are individualized, the postal service provider is physically limited in the number of customers that can be serviced by the number of postal boxes. This results in wasted physical space since many of the postal boxes go unused for substantial periods of time. In addition, customers are often forced to pay for a postal box, typically on a monthly basis, whether or not they receive any deliveries at that postal box.

### SUMMARY OF THE INVENTION

In one aspect of the present invention a method for retrieving and storing packages includes depositing a package for a registered user in one of a plurality of storage units at a delivery node site and notifying the registered user that a package is available for retrieval at the pre-determined delivery node site. The delivery of the package at the delivery node site may further include authenticating the delivery service personnel prior to package deposit and authenticating registered users prior to package retrieval.

In another aspect of the present invention a multi-user package retrieval and storage system includes one or more delivery node systems wherein the delivery node systems have a plurality of storage units and a locker controller for controlling access to the storage units and a back office system in electrical communication with the locker controllers. The back office system may process and store transactions and enable package tracking, customer notification and account management. The package retrieval and storage system may also include a user station for interfacing with users of the system. In addition, in one embodiment the delivery node systems may electrically communicate with the back office systems via a communication network such as for example the Internet.

### BRIEF DESCRIPTION OF THE DRAWINGS

These and other features, aspects, and advantages of the present invention will become better understood with regard to the following description, appended claims, and accompanying drawings where:

FIG. 1 is a simplified block diagram of a package retrieval and storage system comprising a plurality of delivery nodes coupled to a back office system in accordance with an exemplary embodiment of the present invention;

FIG. 2 is a simplified block diagram of another package retrieval and storage system wherein the back office system includes one or more traffic directors to manage the traffic load between multiple servers in accordance with an exemplary embodiment of the present invention;

FIG. 3 is a flow chart illustrating the operation of the package retrieval and storage systems of FIGS. 1 or 2 in accordance with an exemplary embodiment of the present invention;

FIG. 4 is a perspective of a fixed delivery node site having a locker unit and user station in accordance with an exemplary embodiment of the present invention;

FIGS. 5a-c are front side and plan views of the locker unit illustrated in FIG. 4 in accordance with an exemplary embodiment of the present invention;

FIG. 6 is a flow chart illustrating an account signup procedure for remote delivery node site in accordance with an exemplary embodiment of the present invention;

FIG. 7 is a flow chart illustrating an authentication procedure at a remote delivery node site in accordance with an exemplary embodiment of the present invention;

FIG. 8 is a flow chart illustrating a package delivery procedure at a remote delivery node site in accordance with an exemplary embodiment of the present invention;

FIG. 9 is a flow chart illustrating a package pickup procedure at a remote delivery node site in accordance with an exemplary embodiment of the present invention;

FIG. 10 is a flow chart illustrating the maintenance procedures for a remote delivery node site in accordance with an exemplary embodiment of the present invention;

FIG. 11 is a flow chart illustrating an account sign up procedure for a fixed delivery node site in accordance with an exemplary embodiment of the present invention;

FIG. 12 is a flow chart illustrating an authentication procedure for a fixed delivery node site in accordance with an exemplary embodiment of the present invention;

FIG. 13 is a flow chart illustrating a package delivery procedure for a fixed delivery node site in accordance with an exemplary embodiment of the present invention;

FIG. 14 is a flow chart illustrating a package pickup procedure for a fixed delivery node site in accordance with an exemplary embodiment of the present invention;

FIGS. 15a and 15b are illustrations of a card used for access by registered users of an exemplary package retrieval and storage system in accordance with an exemplary embodiment of the present invention; and

FIGS. 16a and 16b are illustrations of a card used by delivery service personnel for access to an exemplary package retrieval and storage system in accordance with an exemplary embodiment of the present invention.

### DETAILED DESCRIPTION

The present invention provides a multi-user package retrieval and storage system that overcomes the drawbacks of conventional postal boxes. An exemplary embodiment of the present invention provides a registration-based, electronic, multi-user delivery node. In accordance with an exemplary embodiment the delivery node system may comprise a locker unit having a plurality of lockers of varying sizes and a user station containing for example, a card reader, keypad and display. In the described exemplary embodiment access to a locker within the locker unit may be restricted to registered users using any of a variety of access control techniques such as for example, unique identification numbers or user access cards and personal identification number (PIN).

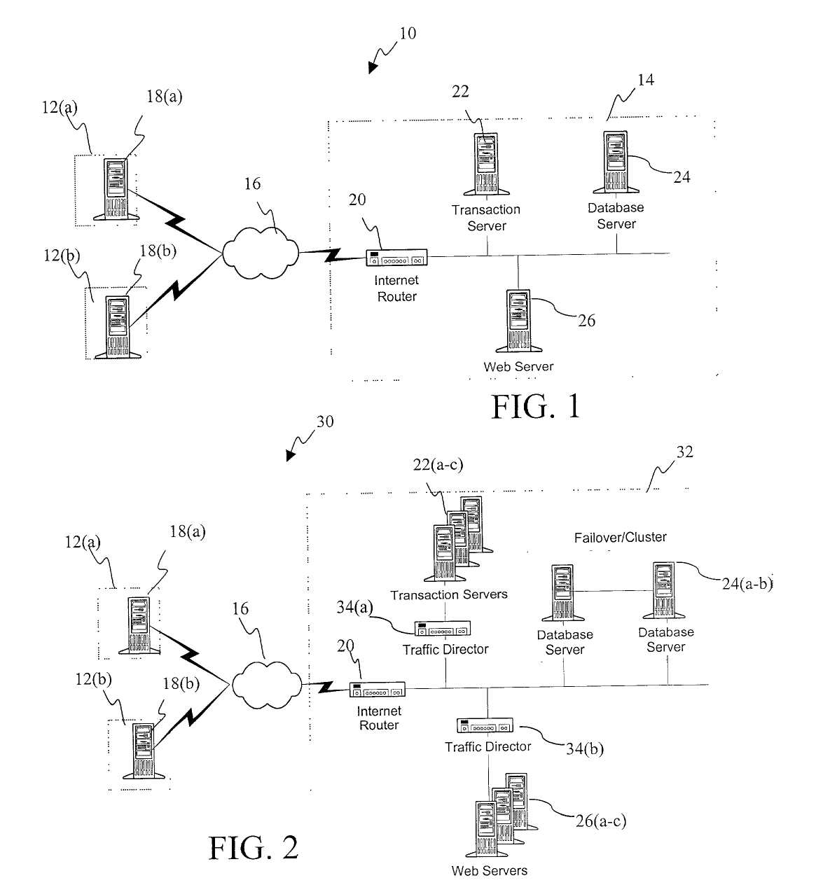

FIG. 1 is a simplified block diagram of an exemplary package retrieval and storage system comprising a plurality of delivery node sites 12(a) and 12(b) electronically coupled to a back office system 14 via a communication network 16. In one embodiment, the communication network may comprise the Internet. It will be understood by those skilled in the art that the communication network may take many different forms, such as a local area network (LAN), wide area network (WAN), wired telephone network, wireless network, or any other network that supports data communication between respective entities. In accordance with an exemplary embodiment the back office system may be capable of communicating with one or more delivery node sites simultaneously.

In the described exemplary embodiment, the user station of each locker unit may include a locker controller 18(a) and 18(b) that processes local transactions with registered users. The locker controller may take many different forms, and in one illustrative embodiment may comprise a personal computer. Alternatively, the locker controller may comprise any other device that has processing capabilities and that may engage in communication over a communication network. In the described exemplary embodiment the locker controllers may communicate transaction information on a semi-regular bases via the communication network to the back office system.

In the described exemplary embodiment the back office system may include an Internet router 20, a transaction server 22, a database server 24 and a web server 26. In the described exemplary embodiment the Internet router 20 handles incoming and outgoing traffic over the communication network 16. The transaction server 22 processes transactions with registered users and may in one embodiment, interface with merchant credit card billing systems. An exemplary database server 24 may store historical transaction activity and maintain registered user records.

In an exemplary embodiment the web server 26 may host a website that allows communications with registered users and commercial delivery service providers via the Internet. In accordance with an exemplary embodiment, registered users may utilize the customer website (e.g., www.DeliveryNode.com) to activate subscriptions, check on the status of deliveries, add money to their account, and perform other account management tasks.

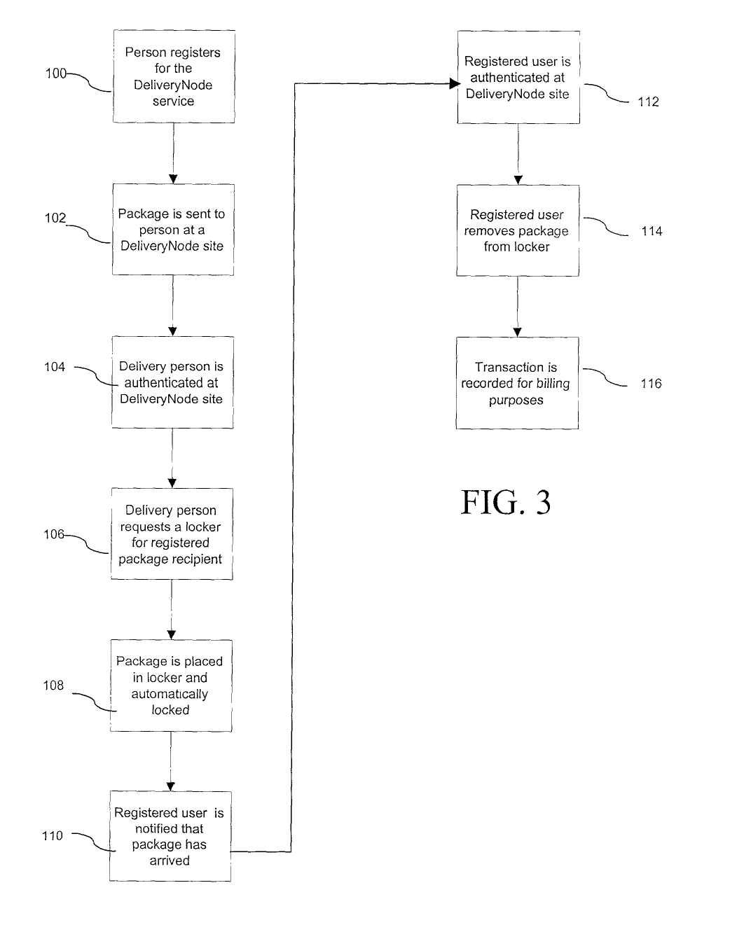

FIG. 2 illustrates a block diagram of another package retrieval and storage system 30 wherein like reference numerals are used to represent like components. The alternate package and retrieval system 30 is substantially similar to the system of FIG. 1. However, the back office system 32 of the alternate another package retrieval and storage system 30 may include a plurality of transaction servers 22(a-c), web servers 26(a-c) and database servers 24(a-b) to handle a greater capacity of registered users. In this embodiment traffic directors 34(a-b) may be utilized to manage the distribution of traffic to and from the plural transaction servers and web servers, respectively. In an exemplary embodiment the database servers may be configured with a fail-over capability to prevent the loss of data.

In accordance with an exemplary embodiment registered users are able to deliver and receive packages from the system using their access card. For example FIG. 3 is a flow chart illustrating the operation of an exemplary package retrieval and storage system. In the described exemplary embodiment a user or delivery service may register with the package retrieval and storage service 100 by any of a variety of techniques including for example, electronic registration over a communication network, telephonic registration, or by completing and submitting a traditional application form. Once registered, a user may arrange for package delivery to any of the delivery node sites in the described exemplary package retrieval and storage system.

In accordance with an exemplary embodiment the back office system may be automatically notified when a package is delivered to a delivery node site 102. In practice the described exemplary system may control access to the locker unit by delivery services personnel. For example, an exemplary system may determine whether delivery services personnel are authorized to deliver or receive packages to or from a delivery node site 104 prior to providing access to the locker unit. For example, in one embodiment, delivery services personnel may be required to login at a user station by typing a unique identification (ID) or inserting an access card and typing their personal identification number (PIN). In the described exemplary embodiment a subset of all user account information may be stored locally in the locker controller and can be instantly checked. If no match is found with the locally stored data, the locker controller may query the back office database server to delivery person.

In one embodiment registered users do not have a pre-assigned locker. Rather, the lockers may be dynamically assigned to a registered user when a properly authenticated delivery person requests a locker 106 for a registered package recipient. Therefore, in the described exemplary embodiment the size of the locker may be selected to accommodate the size of the particular package that is being delivered. In the described exemplary embodiment the package may then be deposited in the allocated locker and automatically locked 108.

In the described exemplary embodiment, the back office system may then notify the registered user that a package has been delivered and is ready to be picked up 110. In accordance with an exemplary embodiment the back office system may notify the registered user via e-mail, voice, facsimile or the delivery node website that a package has been delivered for them at a particular delivery node site. The registered user may then proceed to the delivery node unit at their leisure to withdraw the package from their temporarily assigned storage unit. In accordance with an exemplary embodiment the package retrieval and storage system may authenticate registered users who arrive at the delivery node site and log in at the user station 112. In the described exemplary embodiment the locker controller may identify and open the particular locker containing the package for the particular registered user allowing that user to retrieve the delivered package 114.

In the described exemplary embodiment the back office system may provide transaction management, account management, delivery notification, and payment processing. In an exemplary embodiment the locker controller may forward a transaction record to the back office system which records the transaction 116, including for example a time and date stamp of package delivery and retrieval, locker location and identification of deliverer and recipient. In the described exemplary embodiment the registered user may only be charged for the time that the locker is in use, and a large number of registered users may share a more limited number of lockers.

In accordance with an exemplary embodiment, the delivery node site may also facilitate the return of packages to the originator. After re-labeling the package, the registered user delivers it to a delivery node site and enters the ID number of the shipper. In accordance with an exemplary embodiment the locker controller may automatically notify the back office system when a registered user delivers a return package to a delivery node site. The back office system may then notify the shipper, via an e-mail message, voice message, facsimile message etc. that there is a package available for pickup.

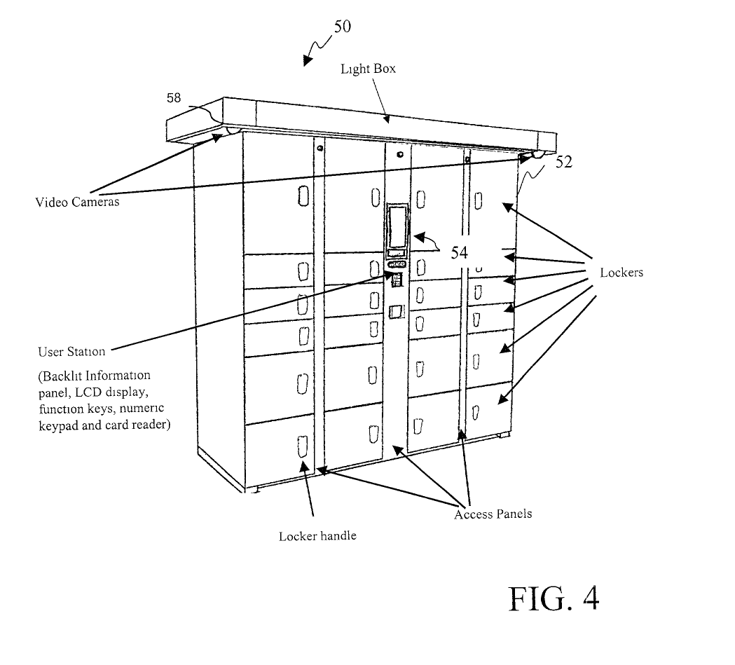

FIG. 4 illustrates an exemplary delivery node site 50 comprising a locker unit 52 and user station 54. In accordance with an exemplary embodiment the user station 54 may be located in the center of the locker unit 52 and may comprise for example, a backlit display panel, multi-line LCD display, numeric keypad and proximity card reader. The locker unit may be uniquely configured to accommodate the needs of a particular delivery node site. For example, an exemplary locker unit may be configured to include any number of storage units of differing sizes to efficiently accommodate differing package sizes.

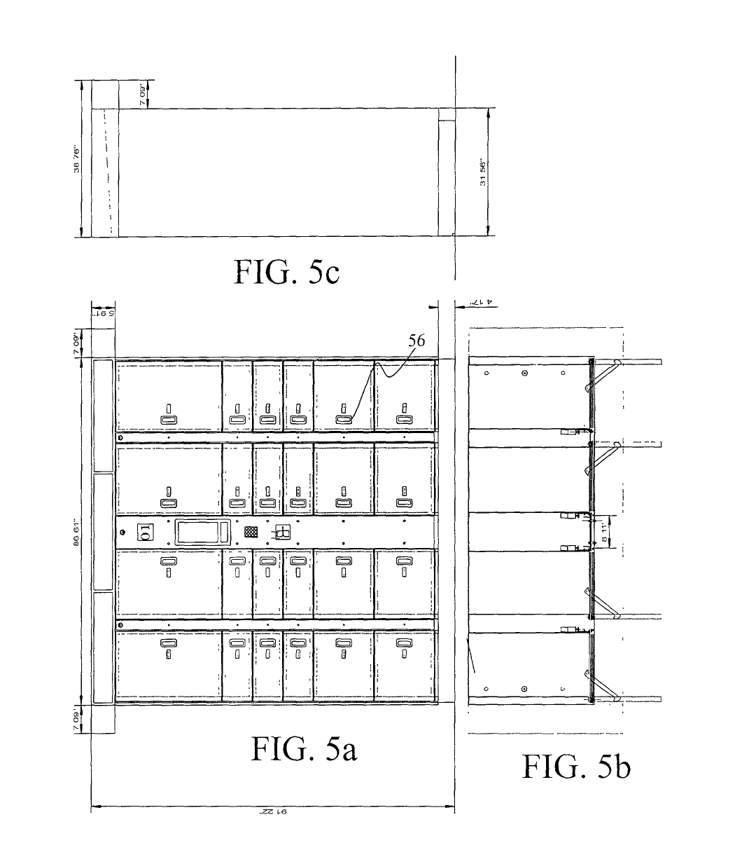

For example, an exemplary locker unit may include four columns of lockers having four to six lockers of differing sizes. The modular design of the locker units allows for a variety of configurations and efficient use of space. Additional locker units can be placed side by side or back to back. FIGS. 5(a-c) illustrate a front, side and plan view of an exemplary locker unit.

In accordance with an exemplary embodiment each locker (also known as a storage unit) may be numbered and may contain a locking mechanism such as for example an electromechanical lock. In one embodiment the locker doors may include slots that house the electromechanical locking mechanisms. In an exemplary embodiment the doors may include handles 56 that allow the doors to be pulled open by the user. In addition the doors may be spring loaded to ensure each door is properly closed when pushed.

In the described exemplary embodiment a security system at the delivery node site may provide access control, video surveillance and anti-tampering alerts. For example, referring back to FIG. 4, in one embodiment, video surveillance cameras 58 may be located on the locker unit to digitally record and store all locker activity for a specified period of time. Further, each locker unit may be equipped with an audible and remote alarm that may be triggered by any tampering with the locking mechanisms. The described exemplary locker unit may include an over-ride feature that allows at least a portion of the lockers to be opened simultaneously should inspection be required. Otherwise all lockers remain in the locked position except when deliveries and retrievals are in progress.

In the described exemplary embodiment, the locker units may be conveniently located at a variety of locations within a city or community. For example, in an exemplary embodiment of the present invention remote site delivery nodes may be utilized to provide package retrieval and storage services at remote sites such as, for example, transit stations, airports, etc. where there is no fixed group of users. In this embodiment registered users may designate a remote delivery node site for package retrieval when purchasing an item or arranging for the delivery of a particular package.

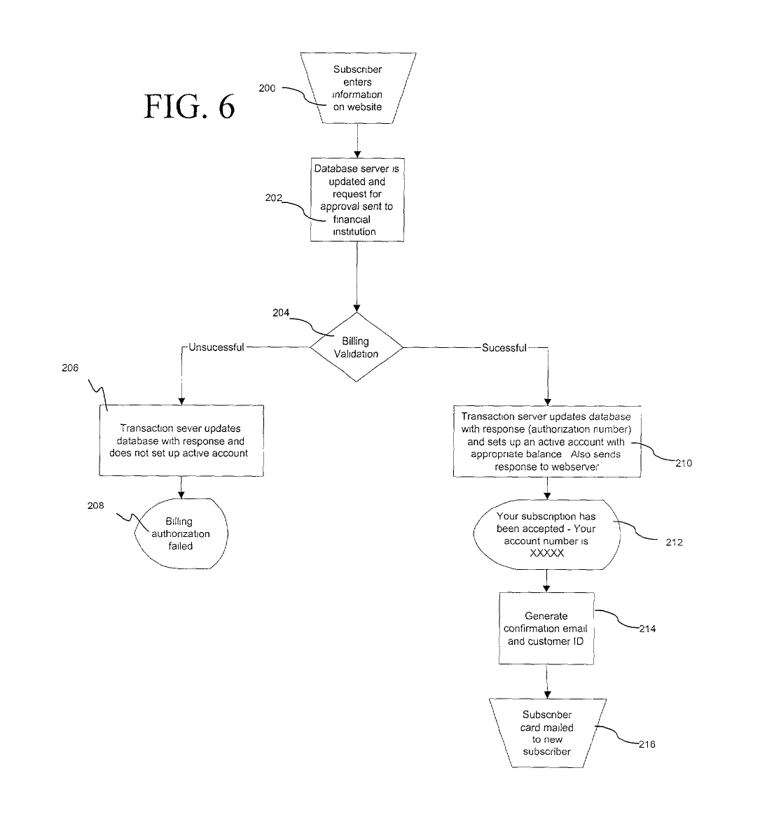

FIG. 6 is a flow chart illustrating an exemplary account signup process for a remote site package retrieval and storage system. In an exemplary embodiment commercial delivery services and prospective users may signup for an account on the delivery node website. In this embodiment contact and billing information such as for example a credit card, debit card, bank account number may be entered at the website as part of the signup process 200.

In the described exemplary embodiment the database server may be updated to include the relevant signup information 202. In the described exemplary remote site embodiment, the transaction server may query the merchant credit card service, bank or other pertinent billing institution to determine if any required payments are approved 204. In one embodiment registered users are prompted to add money to their account at the time of subscription. In addition, in operation, each transaction may result in a debit to the user's account. Once the account balance falls below a predetermined threshold, an exemplary system may prompt the registered user to replenish their account.

In the described exemplary embodiment the transaction server in the back office system handles these functions by interfacing with the merchant credit card service or other financial network. If the required payments are not approved the described exemplary system may update the database with the response from the financial institution and does not establish an account for the perspective user 206. The described exemplary system may display a message notifying the perspective user that the billing authorization failed 208.

If the required payments are approved, the data base server stores the signup transaction information and the transaction server establishes an active account for the user with an appropriate account balance 210. In addition, an exemplary remote site system may notify the user via e-mail, telephone etc. that his or her subscription has been accepted and provides the user with a unique customer identification and account number 212. In the described exemplary embodiment a subscriber access control card may be forwarded to the new registered user 216 for use when logging in at a user station in a delivery node site.

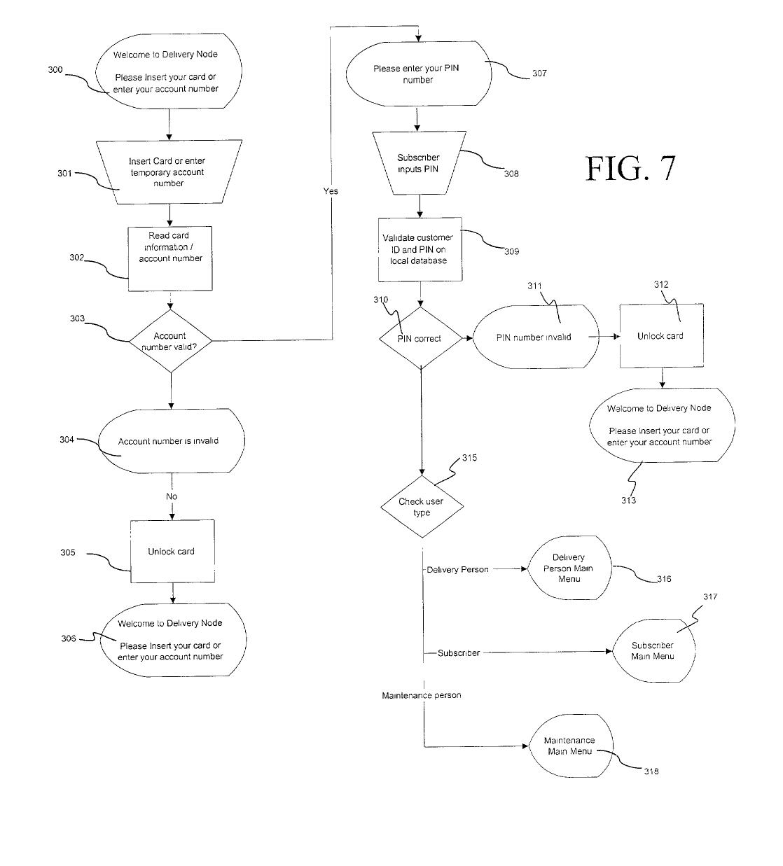

FIG. 7 is a flow chart illustrating login at a user station of a remote delivery node site. In accordance with an exemplary embodiment the remote site user station may display a welcome screen that prompts both delivery services personnel and subscribers to login at the user station by entering their unique ID or inserting an access card and entering their personal identification number (PIN) 300.

In the described exemplary embodiment the user station may read the inserted card information or account number 302. The described exemplary system may then determine if the account information is valid 303. In one embodiment a subset of all user account information may be locally stored in the locker controller and can be instantly checked. However, if a match is not found with the locally stored data, the locker controller may query the back office database server to determine if there is any updated information. If the account number is not valid 304 the described exemplary system releases the card 305 and returns to the welcome screen 306.

If the account number is valid an exemplary system may prompt the user to enter a PIN number 307. The described exemplary system may then validate the account number and PIN number either locally or on the back office database server 309. If the PIN number is not valid 311 the described exemplary system releases the card 312 and returns to the welcome screen 313. If the PIN number is valid an exemplary system may determine whether the user is a subscriber, a delivery services person or a maintenance person 315 and display a menu appropriate for the user type 316, 317 and 318.

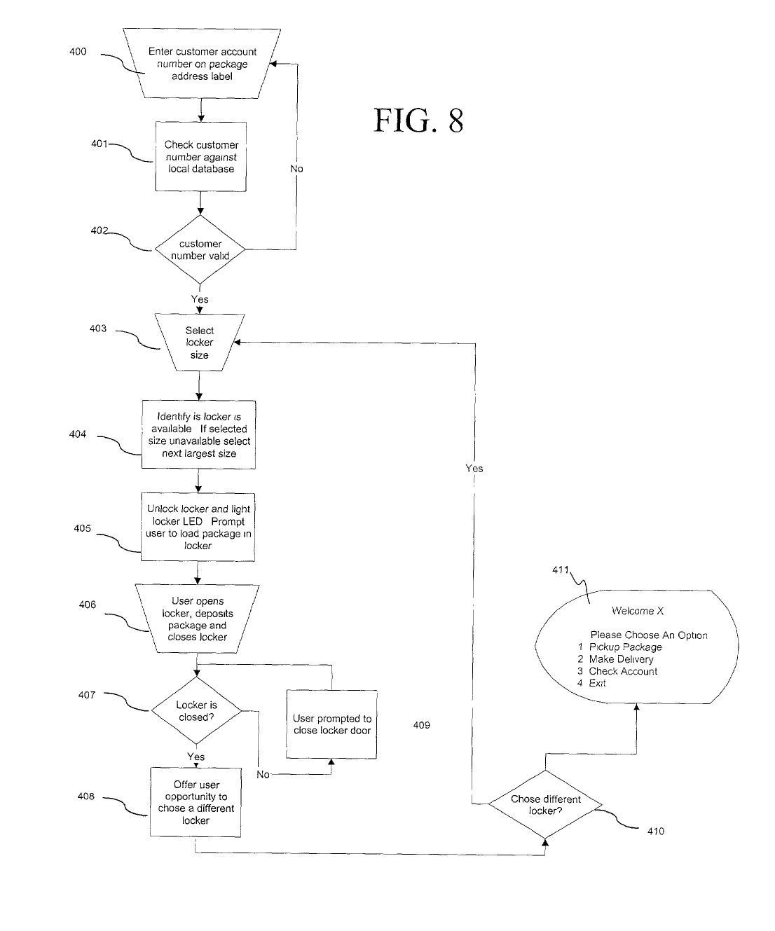

Once logged in, the user has access to the locker unit to make or retrieve deliveries. For example, FIG. 8 is a flow chart illustrating an exemplary method for delivering packages to a remote delivery node site. In the described exemplary embodiment delivery services personnel will enter the customer account number displayed on the package address label 400. An exemplary system may then verify the customer account number 401 in the local database. If the customer account number is invalid an exemplary system may prompt the user to re-enter customer account data 400. If the customer account number is valid 402 an exemplary system may display a menu prompting the user to select a desired locker size 403.

If the selected size is not available an exemplary system may automatically select the next largest available locker 404 or prompt the user to select a different locker 410. If the desired locker size is available an exemplary system may unlock the storage unit and activate an indicator, such as, for example, a light emitting diode (LED) on the storage unit while prompting the user to load the package in the indicated storage unit. The user may then open the storage unit, deposit their package and close the storage unit door 406. The described exemplary system may then verify that the storage unit door is properly shut 407 and if not prompt the user to close the storage unit door 409.

If the door is properly closed an exemplary system may offer the user an opportunity to choose a different locker 408 that may be more appropriate for the particular package that is being delivered. If the user does not want to choose a different locker the users card is released and the system returns to the welcome menu 411. If the user wants to choose a different storage unit an exemplary system again prompts the user to select a locker size 403 and repeats the steps leading to the deposit of the package in an appropriate storage unit. The described exemplary system may then notify the registered user that a package is available for pick-up. In accordance with an exemplary embodiment a subscriber may drop off a package to be picked up by the delivery services personnel in the same manner.

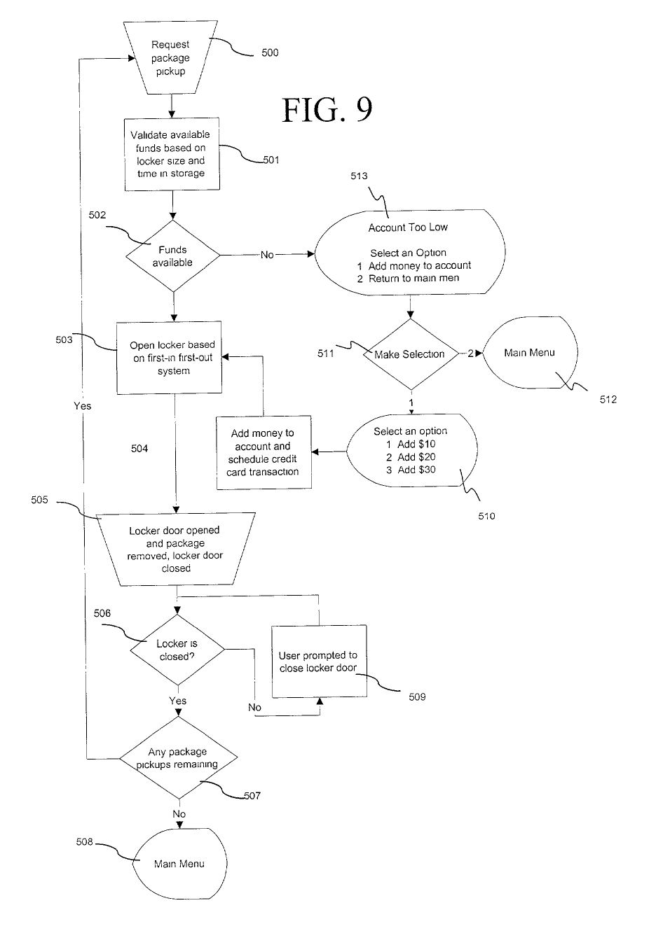

FIG. 9 is a flow chart illustrating an exemplary method for retrieving a package at a remote delivery node site. After login, the registered user or delivery services personnel will be notified on the user station display as to whether they have a package to pick up 500. If the user has a stored package an exemplary system may notify the user of a charge to their account in accordance with the size of the storage unit and the time in storage. An exemplary system may verify that sufficient funds are available in the user account to cover the charge 501. If adequate funds are not available in the user account, an exemplary system may inform the user that adequate funds are not available in their account to cover the current transaction and prompt the user to add money to the account or return to the main menu 513. If the user chooses to add money to his or her account an exemplary system may prompt the user to add one of a plurality of displayed amounts 510 or allow the user to enter an amount to add to his or her account using the numerical key pad.

The described exemplary system may then schedule a monetary or credit transfer from the appropriate billing institution in accordance with the amount entered by the user. The described exemplary system may now open a storage unit containing a package for the particular user on a first in-first out basis 503. The user may then retrieve the package, and close the storage unit door 505. An exemplary system may verify that the storage unit door is closed 506 and prompt the user to close the door if it is not properly secured 509. An exemplary system may then determine if there are additional package pick-ups for this user. If so the described exemplary system may notify the user that they have an additional package to pick up. If not the system may return to the main menu and the locker controller may forward a record of the transaction to the back office system that records the transaction and debits the user's account.

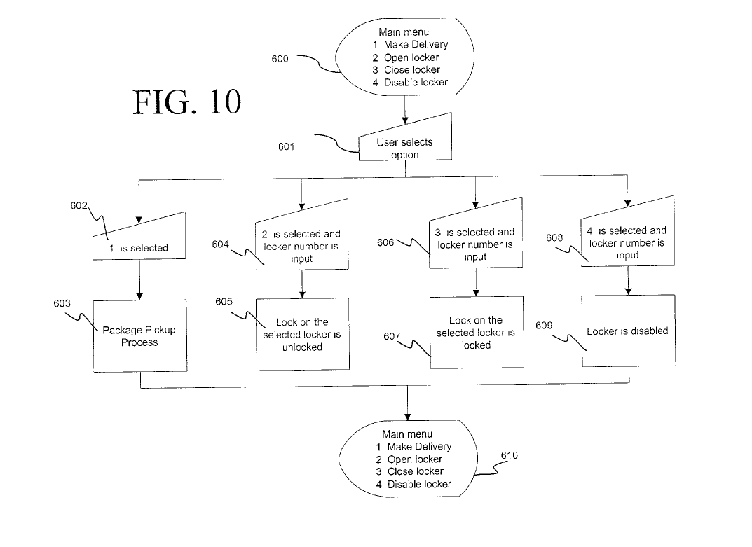

FIG. 10 is a flow chart illustrating an exemplary maintenance menu for a remote delivery node site. In accordance with an exemplary embodiment maintenance personnel may be given access to additional menu choices 600 that allow the maintenance person to select options 601 to verify the status of each locker to be checked (i.e., full or empty) and to open or disable any locker 602-609. The described exemplary system may return to the main menu upon completion of the maintenance test 610.

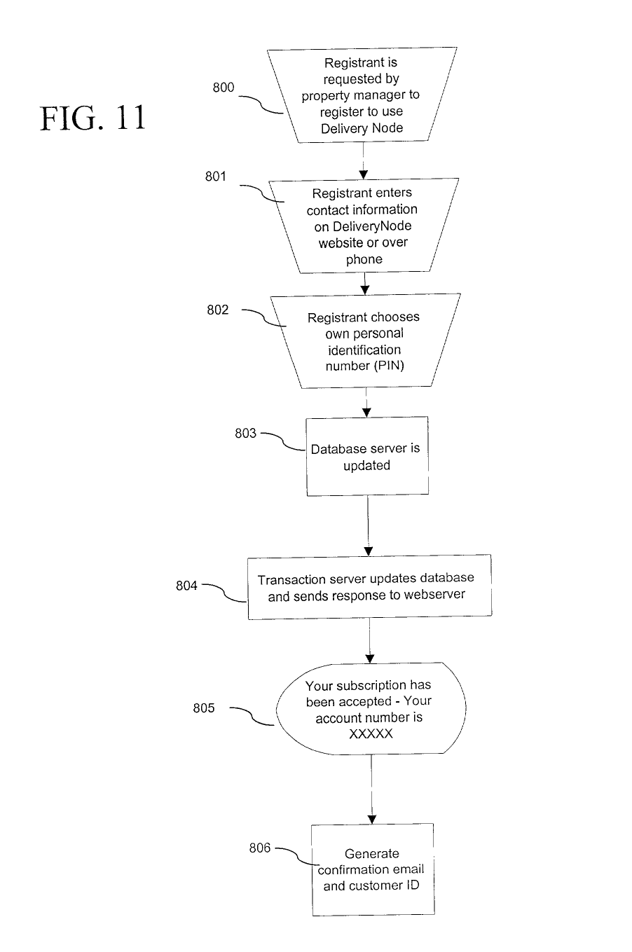

The present invention may also be used to deliver and retrieve packages from fixed sites, such as for example, residential or office complexes that have a relatively fixed group of registered users. In this embodiment packages may be delivered to a registered user at a fixed delivery node site whether or not the user has previously requested such a delivery. FIG. 11 illustrates an exemplary account signup procedure for fixed delivery node sites. As in FIG. 6, an exemplary account signup may occur remotely via a delivery node website, telephonically or in accordance with other techniques commonly used in the fee for services industries 800.

In this embodiment commercial delivery services and prospective users may again be prompted to provide contact information 801. In one embodiment, fees for package delivery to and package retrieval from a fixed delivery node site may be paid by the property manager. Therefore, in this embodiment credit card or alternative billing information may not be required from the prospective user. However, a property manager may choose not to fund the fixed delivery node site and individual users may therefore again be required to enter billing information that may be verified as previously described with respect to FIG. 6.

An exemplary system may allow a registrant to choose a PIN or automatically assign a PIN to the perspective user 802. In the described exemplary embodiment the web server forwards the sign-up information to the data base server that stores the information 803. The transaction server may then update the local database on the selected fixed delivery node 804. In accordance with an exemplary embodiment, the web server may display a menu informing the user that his or her subscription has been accepted and providing that user with his or her account number 805. The described exemplary system may then generate a customer ID that may be forwarded to the registrant in a confirmation e-mail, voice mail, letter, etc. In the described exemplary embodiment, a subscriber access control card may also be forwarded to the new registered user for use when logging in at a user station in a fixed delivery node site.

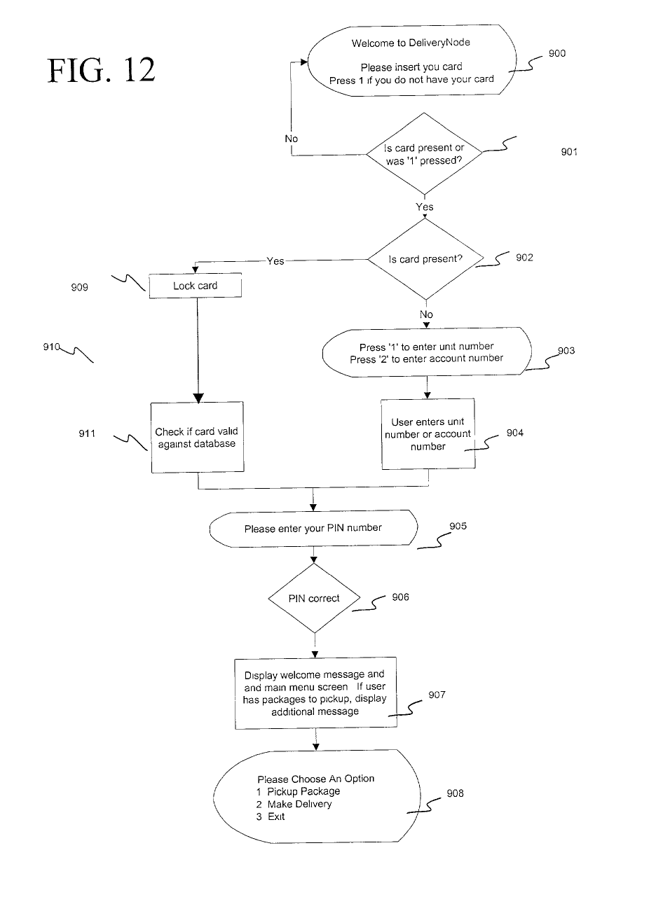

FIG. 12 illustrates an exemplary login procedure at the user station of a fixed delivery node site. In an exemplary embodiment of the present invention a user can login using an access card, an account number or their unit number as in the case of a residential complex 900. If an access card is used the described exemplary system may lock the card 909 and verify the validity of the card in the local database 911. If a match is found and the card is valid, the described exemplary system may prompt the user to enter a PIN number 905.

If an access card is not used an exemplary system may prompt the user to enter the unit number of the fixed delivery node site or to enter an account number 903. The described exemplary system may then validate the information entered by the user 904 and if valid may again prompt the user to enter a PIN number 905.

An exemplary system may then validate the PIN number 906 and if valid display a welcome menu and a message notifying the user that one or more packages are currently being stored for retrieval 907. The described exemplary system may then prompt the user to select a service such as for example pick-up a package, make a delivery or exit 908.

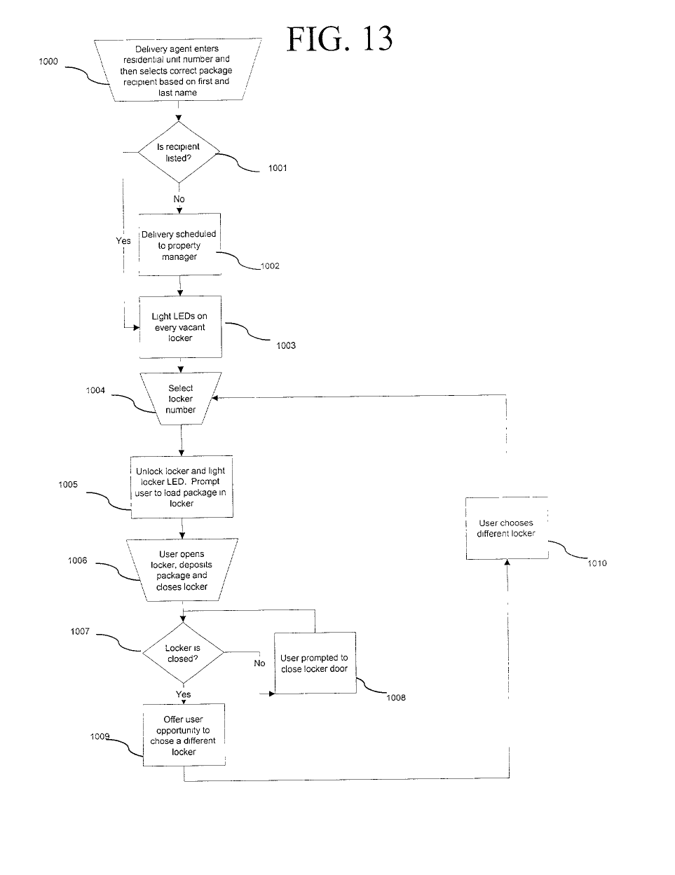

FIG. 13 illustrates an exemplary package delivery method for fixed delivery node sites. In an exemplary fixed node package retrieval and storage system solicited and unsolicited packages may be delivered to a fixed delivery node site. Therefore, in this embodiment user account numbers need not be listed on the package address label. Rather, in an exemplary embodiment a delivery agent may simply enter the unit number of the fixed delivery node site. The described exemplary system may then display a list of registered users who live or work at that address 1000. If the recipient isn't listed an exemplary system may deliver the package to the property manager 1002. Otherwise the delivery agent may select the correct individual for package delivery.

The described exemplary system may then activate an indicator, such as for example an LED, on each of the vacant storage units 1003 and prompt the delivery agent to select an appropriately sized storage unit 1004. The described exemplary system may then open the lock on the selected unit and prompt the user to load the package into the storage unit 1005. The user may then open the door on the storage unit and deposit the package therein. In the described exemplary embodiment, the storage unit may be automatically locked when the user closes the storage unit door 1006. The described exemplary system may verify whether the storage unit door is properly closed 1007, and if not prompt the user to close the door 1008.

If the door is properly closed an exemplary system may offer the user an opportunity to choose a different locker 1009 that may be more appropriate for the particular package that is being delivered. If the user wants to choose a different storage unit an exemplary system may again prompt the user to select a different storage unit 1010 and repeat the steps leading to the deposit of the package in an appropriate storage unit. The described exemplary system may then notify the registered user or property manager that a package is available for pick-up.

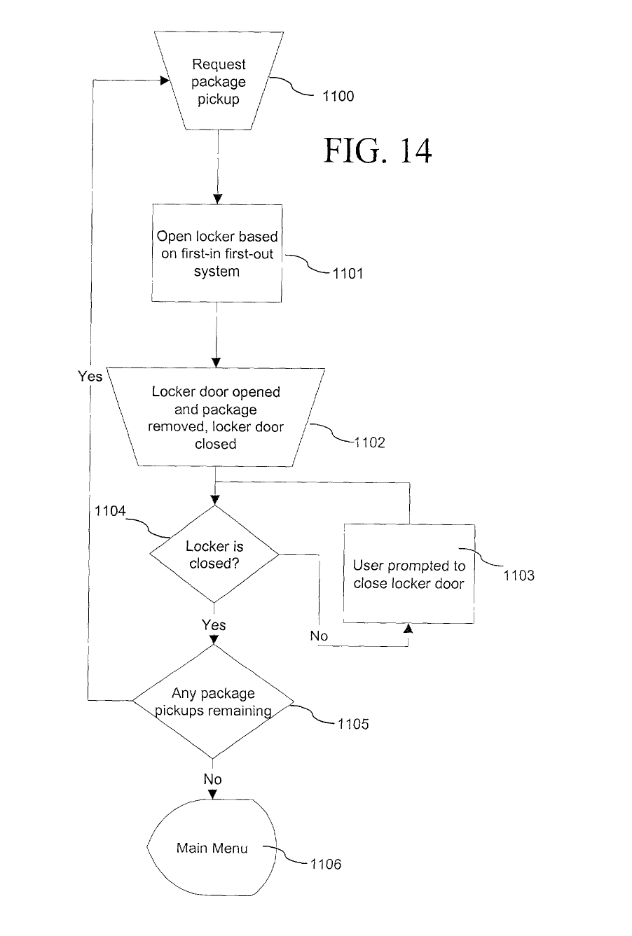

FIG. 14 illustrates an exemplary method for picking up packages at a fixed delivery node site. In accordance with an exemplary embodiment a prospective user, having logged in at the user station, may enter a request to pickup their packages 1100. In the described exemplary embodiment, the property manager may provide the package retrieval and storage services for the registered users so that account balances need not be verified. However, if the property manager is not providing the package retrieval service, an exemplary fixed delivery node system may verify a user's account balances to ensure that adequate funds are available to cover the cost of the current transaction.

In the described exemplary embodiment the fixed delivery node system may store multiple packages in multiple storage units for the same user. In this instance an exemplary system may open the storage units in accordance with a first-in-first out system 1101. After each storage unit is opened and the package has been removed, the user is prompted to close the door 1102 so the storage unit can be secured and classified as vacant and able to accept deliveries for other users.

An exemplary system may verify that the storage unit is properly closed 1104 and if not prompt the user to close the storage unit door 1103. The described exemplary system may then determine whether additional packages are being stored for retrieval by the particular user 1105 and if so opens the next storage unit door in accordance with a first in first out system. When the user has retrieved all of the stored packages the system may return to the main menu 1106.

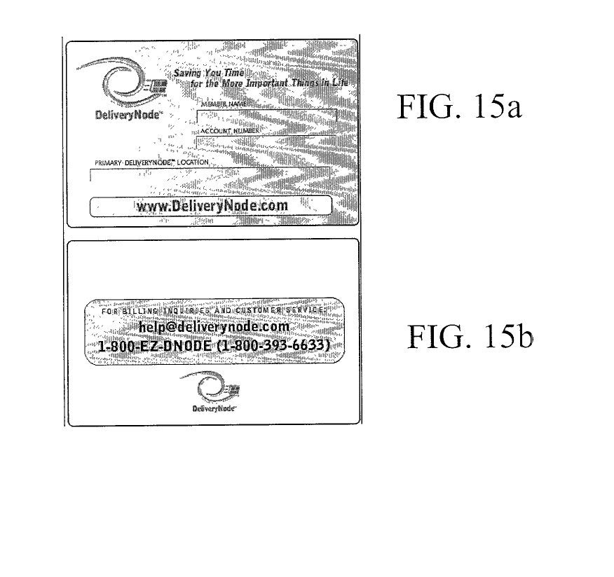

FIGS. 15a and 15b illustrate the front and back of an exemplary registered user card. In one embodiment the card may be a proximity card with a unique identification number that is assigned to the user's account number. Each card may contain for example the user name, account number and the primary delivery node location. The card may also contain contact information that the user can use to obtain assistance.

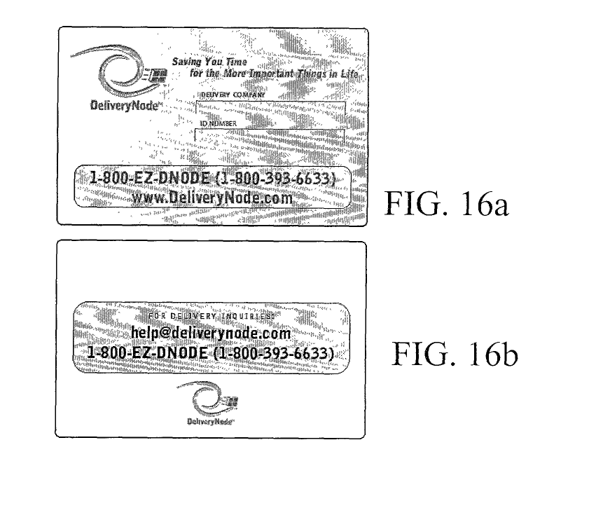

FIGS. 16a and 16b illustrate the front and back of an exemplary delivery service card. Unlike the registered user card, the delivery service card is typically not unique to an individual but to a company. If delivery service agents are collecting returns they will require the same level of secure access as registered users. However, under normal circumstances delivery service agents will only need access to an empty locker. This lessens the need for a unique access card and number for each individual.

Although exemplary embodiments of the present invention have been described, they should not be construed to limit the scope of the appended claims. Those skilled in the art will understand that various modifications may be made to the described embodiment and that numerous other configurations are capable of achieving this same result. Moreover, to those skilled in the various arts, the invention itself herein will suggest solutions to other tasks and adaptations for other applications. It is the applicants intention to cover by claims all such uses of the invention and those changes and modifications which could be made to the embodiments of the invention herein chosen for the purpose of disclosure without departing from the spirit and scope of the invention.

What is claimed is:

1. A method for retrieving and storing packages, comprising:
depositing a package for a registered user in one of a plurality of access controlled storage units at a delivery node site; and
notifying the registered user that a package is available for retrieval at said pre-determined delivery node site.

2. The method of claim 1 further comprising authenticating delivery service personnel at said predetermined delivery node site prior to providing access to said storage units.

3. The method of claim 2 wherein authenticating said delivery service personnel comprises validating an account number and corresponding identification number.

4. The method of claim 1 further comprising entering a customer account number in a user station.

5. The method of claim 4 further comprising validating said customer account number.

6. The method of claim 1 further comprising requesting a storage unit for deposit of said package.

7. The method of claim 6 wherein requesting a storage unit further comprises selecting a storage unit size.

8. The method of claim 1 further comprising requesting package retrieval.

9. The method of claim 8 further comprising authenticating said registered user.

10. The method of claim 9 wherein authenticating said registered user comprises validating account number of said registered user and corresponding personal identification number.

11. The method of claim 9 further comprising validating balance of registered user's account.

12. The method of claim 11 further comprising opening the storage unit that contains said package in accordance with said account validation.

13. The method of claim 1 further comprising recording transaction for billing purposes.

14. The method of claim 13 wherein recording said transaction for billing purposes comprises recording date and time of package deposit and pickup, and recording size of storage unit.

15. The method of claim 2 further comprising entering a unit number in a user station.

16. The method of claim 15 further comprising selecting package recipient from a package recipient list.

17. A multi-user package retrieval and storage system, comprising:
one or more delivery node systems having a plurality of storage units and a locker controller for controlling access to said storage units; and
a back office system in electrical communication with said locker controllers.

18. The multi-user package retrieval and storage system of claim 17 wherein said one or more delivery node systems further comprise a user station for interfacing with users of said system.

19. The multi-user package retrieval and storage system of claim 18 wherein said user station comprises a proximity card reader for authenticating users.

20. The multi-user package retrieval and storage system of claim 18 wherein said user station comprises a keypad as an input device for users.

21. The multi-user package retrieval and storage system of claim 18 wherein said user station comprises a display for displaying messages to users.

22. The multi-user package retrieval and storage system of claim 17 wherein said one or more delivery node systems further comprise a security system.

23. The multi-user package retrieval and storage system of claim 17 wherein said one or more delivery node systems electrically communicate with said back office system via a communication network.

24. The multi-user package retrieval and storage system of claim 23 wherein said communication network comprises a wide area network.

25. The multi-user package retrieval and storage system of claim 24 wherein said wide area network comprises the Internet.

26. The multi-user package retrieval and storage system of claim 17 wherein said back office system comprises a router for managing incoming and outgoing traffic over said communication network.

27. The multi-user package retrieval and storage system of claim 17 wherein said back office system comprises one or more transaction servers for processing transactions with registered users.

28. The multi-user package retrieval and storage system of claim 17 wherein said back office system comprises one or more database servers for storing transaction activity and maintaining register user records.

29. The multi-user package retrieval and storage system of claim 17 wherein said back office system comprises one or more web servers for hosting a web site that allows communication with users via the Internet.

30. The multi-user package retrieval and storage system of claim 17 wherein said one or more delivery node systems comprise one or more remote delivery node systems and one or more fixed delivery node systems.
